(19) United States
(12) Patent Application Publication
(10) Pub. No.: US 2014/0143108 A1
(43) Pub. Date: May 22, 2014

(54) MOBILE DEVICE PROVISIONING FRAMEWORK SYSTEM

(71) Applicant: MasterCard International Incorporated, Purchase, NY (US)

(72) Inventors: Theresa L. Smith, St. Albans (GB); Colin Tanner, Uxbridge (GB); German Blanco, London (GB)

(73) Assignee: MasterCard International Incorporated, Purchase, NY (US)

(21) Appl. No.: 14/086,192

(22) Filed: Nov. 21, 2013

Related U.S. Application Data
(60) Provisional application No. 61/729,089, filed on Nov. 21, 2012.

(51) Int. Cl. G06Q 20/32

(52) U.S. Cl. CPC G06Q 20/32
USPC 705/35

(57) ABSTRACT

Described are systems, apparatus and methods for simplifying and streamlining mobile payment device provisioning. A mobile device provisioning framework system includes a plurality of components that interact by using standard interface specifications and standard messaging specifications to facilitate the provisioning of mobile devices. In an embodiment, a mobile device provisioning framework system provides standardized interface specifications, standardized messaging specifications, and a plurality of predetermined mobile device standard profiles. The mobile device provisioning framework system receives a selection of a standard profile from an issuer computer, and then provisions a consumer's mobile device based on the selected standard profile.

### CROSS REFERENCE TO RELATED APPLICATION(S)

This application claims the benefit of U.S. Provisional Patent Application No. 61/729,089 filed on Nov. 21, 2012, the contents of which are hereby incorporated by reference for all purposes.

### FIELD OF THE DISCLOSURE

Embodiments disclosed herein generally relate to methods, apparatus and systems for simplifying and streamlining mobile payment device provisioning. In particular, a mobile device provisioning framework system is described that includes a plurality of components that interact by using standard interface specifications and standard messaging specifications to facilitate the provisioning of mobile devices.

### BACKGROUND

Advances in technology are allowing more and more consumers to utilize their mobile devices (such as mobile telephones) to conduct payment transactions at merchant point of sale locations. One technological approach to facilitate such transactions is through the use of near field communication (“NFC”) capabilities of mobile devices. For example, a mobile device may be configured to operate pursuant to the PayPass NFC standards, allowing a mobile device to conduct payment transactions at merchant locations that support the PayPass protocol.

Unfortunately, however, there are a number of obstacles to financial institutions (FIs) and other entities that wish to implement NFC payment applications on mobile devices. For example, it can take a year or more for an issuer FI to enable their payment card portfolio to support mobile payments. These deployments are made particularly complex due to the difficulty in integrating the many components associated with an NFC ecosystem, including interactions between the issuer FI, trusted service managers (“TSMs”), secure element issuers (“SEIs”), different mobile devices and different mobile network operators (“MNOs”). While some standards have been promoted (such as the “Global Platform” NFC standards), the standards do not provide an end-to-end approach for supporting NFC payment programs.

It would therefore be desirable to provide an infrastructure and systems that allow issuers to execute mass deployment of NFC services by scaling through simplicity by creating end-to-end configurations.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings which illustrate exemplary embodiments and which are not necessarily drawn to scale, wherein:

FIG. 1 illustrates a system pursuant to some embodiments in accordance with the disclosure;

FIG. 2 illustrates a first provisioning embodiment according to the disclosure;

FIG. 3 illustrates a further provisioning embodiment according to the disclosure;

FIG. 4 illustrates a service subscription process according to the disclosure;

FIG. 5 illustrates a service installation process using a first embodiment according to the disclosure;

FIG. 6 illustrates a service installation process using a second embodiment according to the disclosure;

FIG. 7 illustrates a service update process according to the disclosure;

FIG. 8 illustrates a service enable/disable process according to the disclosure; and

FIG. 9 illustrates a service removal process according to the disclosure.

### DETAILED DESCRIPTION

A number of terms are used herein for ease of exposition and convenience. For example, the term “PayPass” is used to refer to a contactless payment method promulgated by MasterCard International Incorporated. Those skilled in the art will appreciate that embodiments may be used with other contactless payment schemes as well.

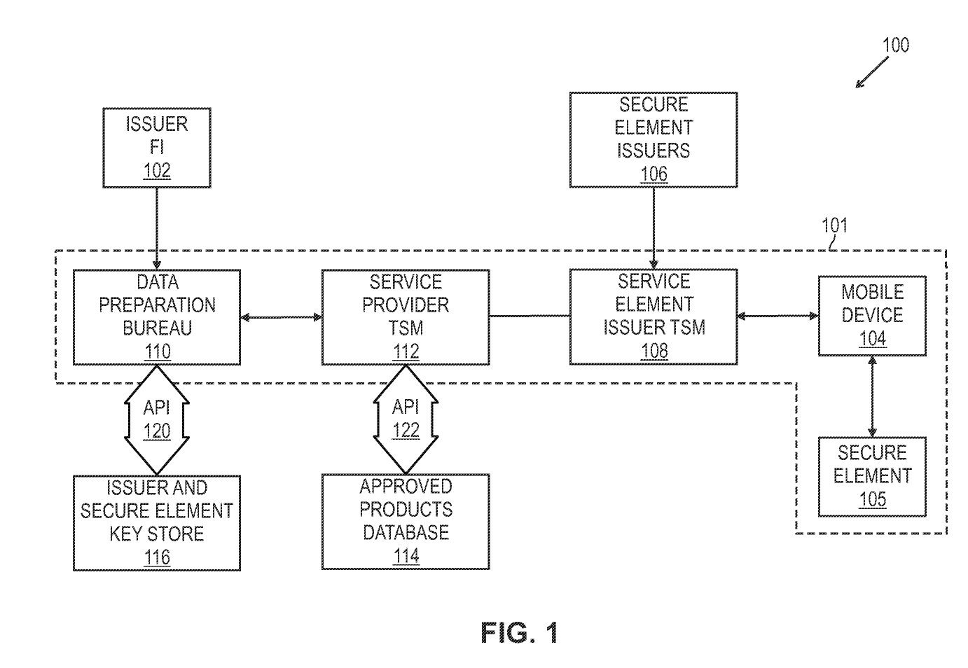

Features of some embodiments will now be described by reference to FIG. 1 which is a block diagram depicting a system 100 pursuant to some embodiments. The blocks shown in FIG. 1 may represent computers and/or computer systems, and a number of entities and/or devices interact to provide mobile payment application provisioning, updates and other support messages and/or transactions. For example, the system 100 may include interactions between one or more issuing financial institution (each, an “issuer”) computers 102 and a number of mobile devices 104 operated by consumers. Interactions between a number of the components and/or entities, pursuant to processes described herein, are facilitated by use of a standardized set of interface and messaging specifications. For example, in FIG. 1, the entities and/or components shown within the dotted lines form a mobile device provisioning framework system 101, and these components all interact using a standard set of messages and interactions (an example of such a mobile device provisioning system framework is the MasterCard Mobile Provisioning Framework (“MMPF”) promulgated by MasterCard International Incorporated). Further, interactions with external entities or components, such as with one or more issuers and Secure Element (“SE”) Key Stores 116 and/or with an Approved Products Database 114, may be standardized through the use of one or more application programming interfaces (“APIs”), such as an Issuer and Key store API 120 and an Approved Products database API 122.

Each of the entities and/or components of FIG. 1 will now be briefly described. The “Issuer” FI computer 102 (also known as the Service Provider or SP) is associated with the organization that issues, delivers and runs the NFC service. In the case of “Mobile PayPass” the Issuer is a bank or other FI. The “Secure Element Issuer” (or SEI) 106 is the owner of the Secure Element (SE) 105 associated with a mobile device 104. For example, in some embodiments, an MNO could be the issuer of a Uniform Integrated Circuit Card (“UICC”) that may be inserted into a mobile handset as the Secure Element (SE) 105. In some embodiments, a mobile device manufacturer could be the issuer of the embedded Secure Element (SE) 105. It should be understood that other types of secure elements, such as a Micro SD card SE and/or a remote SE (which is a SE that is not in the device but is connected via a suitable wireless communications method) may be utilized.

The “Secure Element Issuer Trusted Service Manager” (or SEI TSM) 108 is the Trusted Service Manager on-behalf of the Secure Element Issuer 106 responsible for the access control and content management of the Secure Element 105. The Data Preparation Bureau 110 is an entity or service provider that performs aggregation of card holder personalization data from the Issuer FI 102. The “Service Provider Trusted Service Manager” (or SP TSM) 112 is the entity responsible for the delivery and management of the NFC service on-behalf-of the Issuer 102.

In some embodiments, the “Secure Element” (or SE) 105 is a tamper proof smart card chip capable of providing high security to embed NFC payment services into a mobile device 104. Accordingly, mobile devices configured to operate as NFC payment devices are provided with one or more Secure Elements 105. The “mobile device” 104 may be a mobile telephone, a tablet computer, a personal digital assistant (PDA), a portable music player, a laptop computer, a portable gaming device, a wearable electronic device (such as a wristwatch), or any other electronic portable device. In some embodiments, non-portable devices, such as game consoles, flat-screen televisions, and/or set-top boxes, are configured to be payment devices and thus include an SE.

While only a single issuer FI 102, SEI 108, mobile device 104, and other components are shown in FIG. 1, those skilled in the art, upon reading this disclosure, will appreciate that in use, a large number of different entities will be involved, including, for example, multiple issuers and a plurality of mobile devices.

All actors shown in the system 100 of FIG. 1 need to collaborate to deliver NFC services to the consumer. In order to perform the service delivery, credentials must be provisioned to the Secure Element 105 of the mobile device 104. The SP TSM 112 is responsible to perform such delivery, and in some implementations the provisioning is accomplished Over-The-Air (OTA) through a Mobile Network operated by an MNO.

Currently, despite the existence of standards, the integration between actors or entities of a mobile device provisioning system is typically carried out in a fragmented environment, as each actor or entity may have interpreted and implemented the standards in a different way as applied to their own products. Thus, even if the connections between components or entities implement known standards such as the “Global Platform” (GP) standard and/or other standards, it is still necessary to implement a specific configuration for each project. In addition, it is not unusual for the mobile provisioning workflow to differ for each Issuer FI in accordance with its own preferences. The same applies for all the use cases that may occur after a mobile device has been provisioned, such as processing a mobile telephone number change, a handset stolen or lost incident, and the like.

Thus, the mobile provisioning framework system 101 in accordance with processes described herein provides standardized end-to-end configurations for mobile provisioning (and also for post-provisioning matters), which beneficially reduces the complexity of systems integration. To achieve this, the mobile device provisioning framework system specifies standard end-to-end configurations for the entire value chain. A number of components and interfaces are provided to facilitate interactions. For example, an Issuer/SP TSM standard interface may be provided so that a standardized interface is offered between Issuers and SP TSMs. Such an Issuer/SP TSM standard interface helps issuers to be independent from SP TSM vendor proprietary implementations. Pursuant to some embodiments, such a standardized interface is based on (and/or is an extension of) the Open Application Programming Interface (Open API) of MasterCard International Incorporated and GP specifications, and provides flexibility to support both real time and batch file processing for provisioning requests. The MasterCard Open API provides a means for issuers to choose a number of mobile device services, such as a certified mobile device process to confirm device eligibility, a mobile device provisioning service process, and a key management service process to allow simplified issuer key exchange and distribution throughout the system. In addition, in some embodiments, by supporting a batch file interface, the Issuer/SP TSM standard interface helps issuers to minimize the initial deployment effort to utilize personalization files for the provisioning request to an SP TSM in the same manner as a personalization bureau. Accordingly, in some embodiments, the Issuer/SP TSM standard interface provides support for at least two different use cases, including a first use case where data preparation is done either by the issuer or by a Data Preparation Bureau and EMV prepared data is provided to the SP TSM, and a second use case where personalization data is provided to the SP TSM and the data preparation is done by the SP TSM on behalf of the issuer. EMV is a global standard utilized for payment devices, which covers the processing of credit, debit, and pre-paid payments for cards that contain a microprocessor chip and NFC enabled devices when used at a payment terminal. A company called EMVCo, owned by American Express, JCB, MasterCard and Visa, manages, maintains and enhances EMV Card Specifications to ensure global interoperability of payments (from, for example, chip cards and mobile devices) with acceptance devices such as point of sale terminals and ATMs.

In some embodiments, an SP TSM to SEI TSM interface (SP TSM/SEI TSM standard interface) is provided. In some embodiments, the SP TSM/SEI TSM standard interface may be based on one or more industry standard interface specifications, such as, for example, Global Platform V1.1. However, due to the complexity of such industry standards, in some implementations a simplified configuration is defined to provide an end to end service scenario (providing end to end service including the SP TSM/SEI TSM standard interface together with the Issuer/SP TSM standard interface).

Referring again to FIG. 1, in some embodiments an Approved Products Database 114 and data services based on the MasterCard Open API provide centralized reference, for example to issuers, concerning MasterCard certified mobile devices 104 and secure elements 105. The use of such a database and data services help issuers and MNOs confirm compatibility of devices with NFC payment applications (such as the MasterCard PayPass service). For example, issuers and MNOs can perform an eligibility check to confirm whether a particular mobile device 104 and Secure Element 105 can be used with a particular type of NFC service prior to performing a personalization. For example, in some embodiments the SP TSM 112 receives a mobile device eligibility request from an issuer, and then compares information in that request to data stored in the Approved Products Database 114. If there is a match, then the SP TSM 112 may transmit an eligibility confirmation message to the issuer. In some embodiments, a standardized product identifier for certified mobile devices and Secure Elements will be provided (even across different MNOs), to thus provide improved accuracy and support for a wide variety of mobile devices and Secure Elements.

In some embodiments, based on the MasterCard Open API, one or more entities may provide key management services (“KMS”) to allow simplified issuer key exchange and distribution throughout the system. For example, in some implementations the KMS may be provided by MasterCard International Incorporated as part of the MasterCard Stand-in On-behalf-of service. In such embodiments, issuers need not perform key exchange and distribution with multiple parties. The use of the KMS may further provide simplified embedded SE key management, as “On-behalf-of” key management services may be provided to the SE Issuer as a trusted third party, thereby helping to deploy mobile convergence service based on embedded Secure Elements.

In some embodiments, standardization of mobile device and Secure Element configurations may be provided. Currently, there are a large number of different options and configurations of different mobile devices and Secure Elements. Pursuant to some embodiments, an entity (such as MasterCard International Incorporated) may provide a set of standard recommendations for mobile device and SE configuration to both MNOs and issuers to guarantee a consistent user experience for the OTA provisioning services described herein.

Pursuant to some embodiments, a service provider on boarding process (“SPOB”) is provided that defines a standard process to integrate with an SP TSM. For example, an entity such as MasterCard International Incorporated may provide a standard issuer on-boarding process to certified SP TSMs, thereby helping issuers shorten mobile convergence service deployment time and efforts. In this example, a standard recommendation regarding parameter configuration may be provided that defines the list of standard PayPass parameter profiles for issuers to select based on their business requirements. Accordingly, in some embodiments, the mobile device provisioning framework system may provide issuers with options regarding the provisioning of mobile devices. For example, an issuer may be provided with a menu of predefined options and/or templates, such as ten standard profiles or standardized templates that can be selected in accordance with their business needs. The issuer may then be able to select one of the standard profiles or standard templates based on the type or types of mobile device(s) that the issuer wishes to be able to provision, and/or based on the type or types of Secure Element(s) to be provisioned. In some embodiments, an issuer may have the further option to modify one or more characteristics associated with a standard profile or standard template, for example, in accordance with their business model. In some embodiments, the mobile device provisioning framework system receives a selection of a standard profile or standard template from the issuer, and then operates to provision a consumer's mobile device based on the selected standard profile or standard template. Thus, the mobile device provisioning system uses standard interfaces and provides a predefined and/or limited number of standard profiles or standard templates for selection by issuers (which, in some implementations, can be modified in a limited manner), which simplifies and streamlines the provisioning process for the issuers. In addition, embodiments allow ready integration with Card Personalization Validation (CPV) processes using existing tools to provide end to end services for issuers to configure MasterCard's Mobile PayPass (MMPP) profile/internal test/CPV certification/SP TSM deployment, thereby allowing SP TSM and SEI TSMs to easily test and confirm MMPP.

In some embodiments, an SEI routing interface may be provided which supports third party Service Roaming with a standard end user experience. Such embodiments provide a new user experience to achieve a seamless OTA provisioning service from third party Service Providers with the flexibility to connect to a third party SEI TSM. Such embodiments reduce the integration cost between the SP TSM and the SEI TSM for service roaming by eliminating one-to-one (1:1) integration requirements and instead by using a centralized routing network.

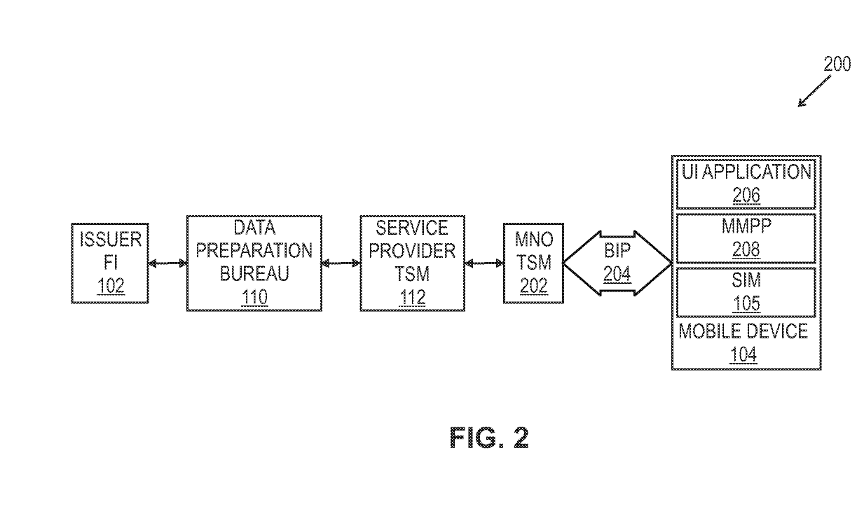

FIG. 2 is a block diagram 200 to illustrate a provisioning process pursuant to some embodiments. In the embodiment depicted in FIG. 2, the components implement a “push” method of provisioning in which provisioning is performed using a Bearer Independent Protocol (BIP) channel. It should be understood, however, that in some embodiments other communications channels could be utilized.

The BIP is a mechanism by which a mobile phone provides a (U)SIM with access to the data bearers supported by the mobile device (for example, Bluetooth, IrDA, and the like) and the network (for example, GPRS, 3G, and the like). A Subscriber Identity Module (SIM) card is used to communicate on GSM-type networks, whereas a USIM is a micro-computer which is able to handle several applications, such as a contactless electronic payment application. The high performance communication BIP can deliver broadband-like data speeds to the USIM, which enables operators to deliver revenue generating services faster, more effectively, and with higher reliability than via an SMS channel. The BIP also allows (U)SIM cards to download data through a mobile devices' high speed data channel (like GPRS and 3G) onto the (U)SIM. Thus, services like Remote File Management (RFM) and/or Remote Application Management (RAM) are significantly faster through BIP, and are thus ideally suited for performing administrative operations, such as loading and/or updating applications on the (U)SIM of a mobile device.

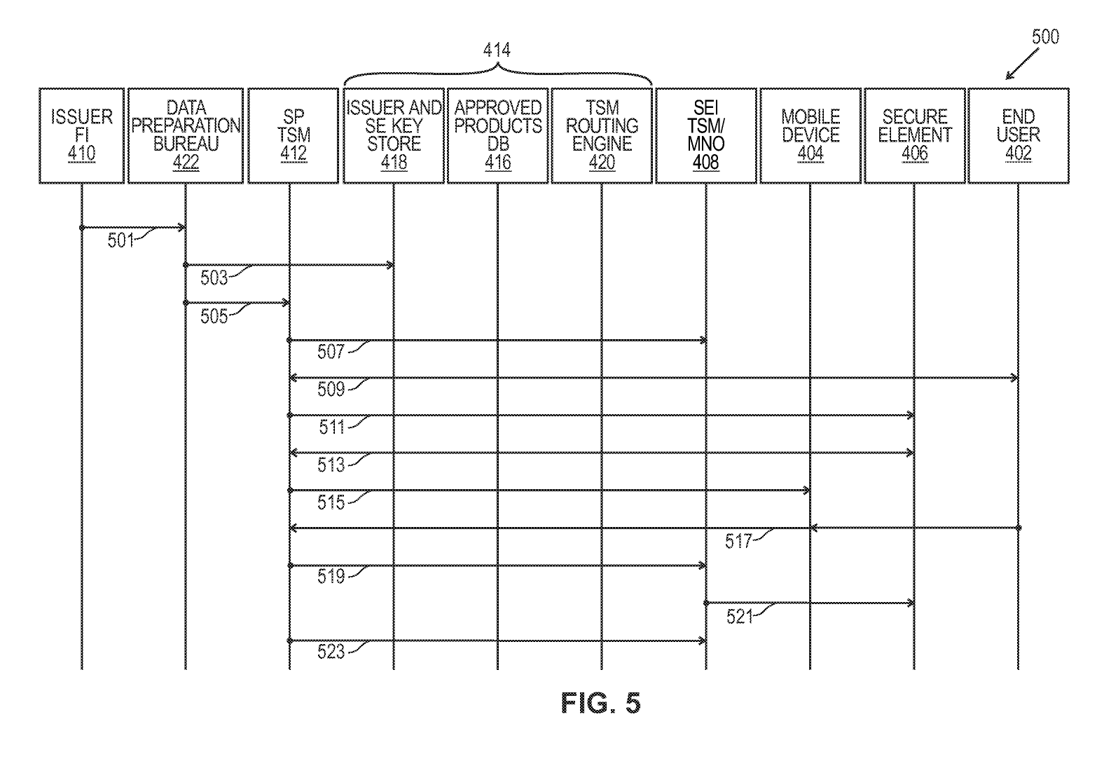

Referring again to FIG. 2, shown are the components used to provision data by way of a “push” process from an MNO TSM 202 to a specific Secure Element (SE) 105 associated with a mobile device 104 of a consumer via a BIP channel 204. In some embodiments, the mobile device 104 includes a User Interface (UI) 206 and a MasterCard Mobile PayPass application 208. In such embodiments, a further provisioning message may subsequently be transmitted to the mobile device 104 (for example, to a mobile payment application of the device) to confirm that provisioning was successful. Further details of such an embodiment concerning data flow from the issuer FI 102, Data Preparation Bureau 110, SP TSM 112, MNO TSM 202 and the mobile device 104 will be described below in conjunction with FIG. 5.

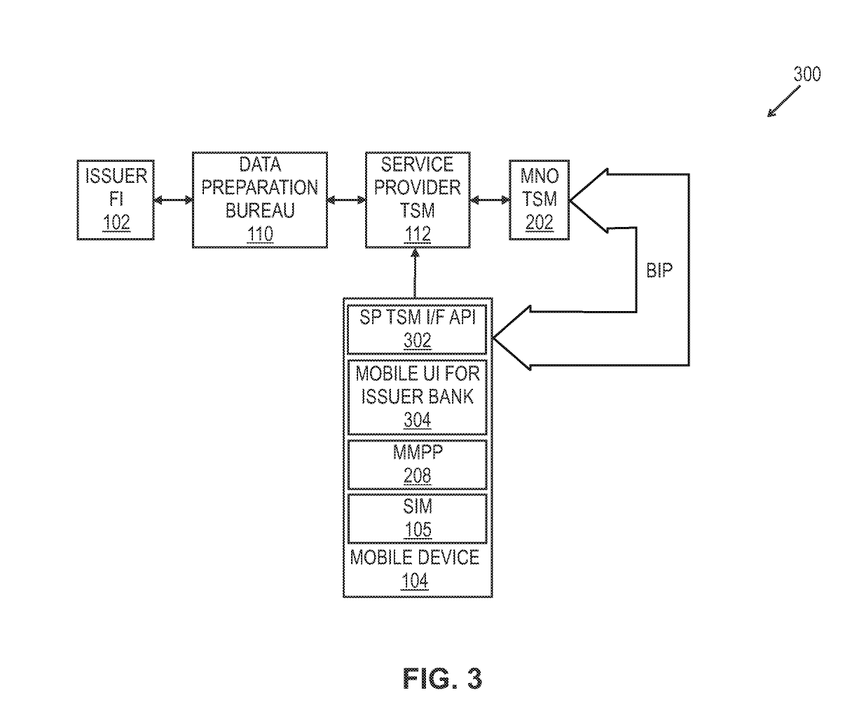

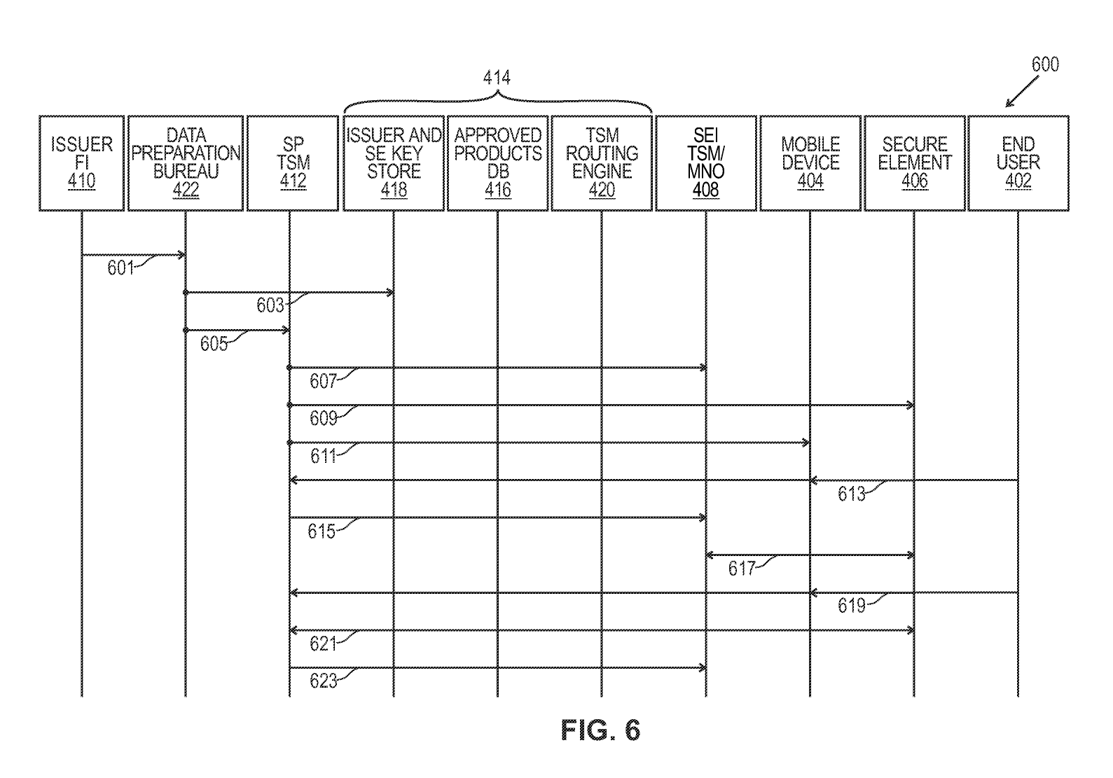

FIG. 3 is a block diagram 300 depicting system components to illustrate another provisioning process pursuant to some embodiments. In the embodiment depicted in FIG. 3, shown are the components used to provision data by way of a “pull” method of provisioning in which mobile data is transmitted over a cellular data connection based on a request from the mobile device 104. Such data may be provided OTA using, for example, an SP TSM interface. Thus the mobile device 104 may be provided with a SP TSM Interface API 302 and a Mobile User Interface (UI) for an Issuer Bank 304 in addition to the MasterCard Mobile PayPass application 208. Further details concerning data flow between the issuer FI 102, Data Preparation Bureau 110, SP TSM 112, MNO TSM 202 and the mobile device 104 of such an embodiment will be described below in conjunction with FIG. 6.

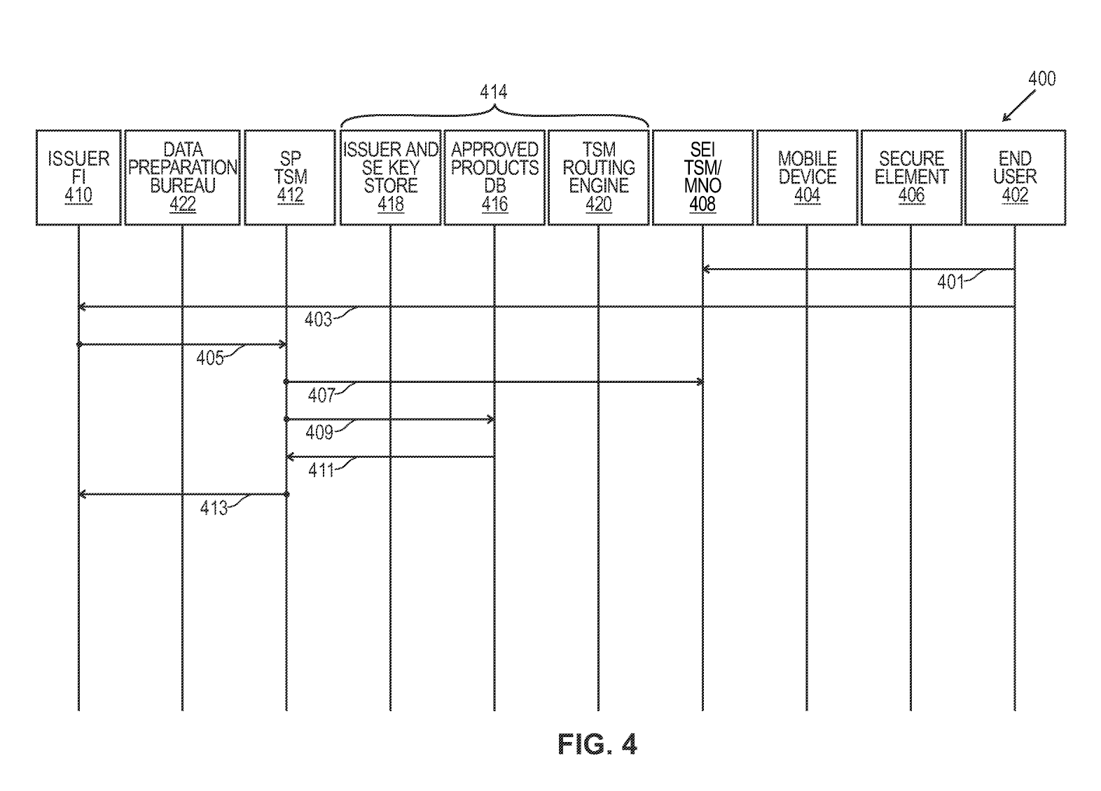

FIG. 4 is a flow diagram illustrating a service subscription process 400 according to an embodiment. In the service subscription process flow, a number of components interact to allow an end user 402 (for example, an owner of a mobile device) to enable a mobile device 404 having a Secure Element (SE) 406 (which may be, for example, a SIM card or UICC) to be provisioned for use as a mobile payment device. The service subscription process begins with the end user transmitting a request 401 to “subscribe” or participate in an NFC payment service to the MNO 408 associated with their mobile device. The first message or interaction 401 occurs between the end user 401 and the MNO 408 (which interaction may occur over a web page or the like) in which information regarding compatible NFC mobile devices and UICCs (Uniform Integrated Circuit Card, which may be the Secure Element (SE) in the mobile device) are obtained. For example, an end user 402 may be informed whether or not his or her mobile device 404 is compatible with the NFC payment system. If the mobile device 404 is compatible, a second message or interaction 403 occurs between the end user 402 and an issuer FI 410 in which the end user subscribes to an NFC mobile payment service (for example, the PayPass system provided by MasterCard International Incorporated). Information associated with the end user 402 and with the mobile device 404 are provided to the issuer FI 410.

Referring again to FIG. 4, a third interaction occurs wherein the issuer FI 410 transmits an eligibility check request 405 to a Service Provider Trusted Service Manager (SP TSM) 412 with the customer data (including information identifying the end user 402 and identifying the mobile device 404). The SP TSM 412 sends 407 the eligibility check request data to a Secure Element Issuer Trusted Service Manager (SEI TSM) that is associated with the MNO 408 for customer NFC service subscription and for compliance of NFC handsets and the UICC (the Uniform Integrated Circuit Card installed within the mobile device). Next, the SP TSM 412 transmits 409 the compatibility check request information (including the mobile device information and UICC data) to a Web Service 414 that provides information associated with approved products. As shown, in some embodiments, the Web Service 414 includes an Approved Products Database 416, an Issuer and Secure Element (SE) Key Store 418, and a TSM routing engine 420, which components are maintained and operated by, or on behalf of, a payment services entity such as MasterCard International Incorporated. The Web Service 414 transmits or returns 411 information identifying whether the customer's mobile device 404 and the UICC installed therein is compatible with the requested service to the SP TSM 412. If the end user is eligible for the NFC payment service and has an NFC-compliant mobile device and UICC, then the SP TSM 412 transmits 413 a positive eligibility check response to the issuer FI 410, and then the issuer FI will initiate back-office processing to determine the customer's 402 eligibility for the NFC service (which may include, for example, a credit check to ensure that the customer 402 has the necessary funds to utilize an NFC payment-enabled mobile device). Also shown in FIG. 4 is Data Preparation Bureau 422, which is utilized when provisioning the mobile device 404 with appropriate payment application data as explained below.

Once the consumer's initial eligibility has been confirmed, and back office processing has been initiated by the issuer FI 410, the mobile device 404 needs to be provisioned with the appropriate application data. One of two approaches may be used (and those skilled in the art will appreciate that others may be used as well). A first approach is illustrated in FIG. 5, wherein provisioning occurs as a “push” to the mobile device; a second approach is illustrated in FIG. 6, wherein the mobile device requests provisioning via a “pull” process.

FIG. 5 is a flow diagram illustrating a “push” provisioning process 500 according to an embodiment. In the embodiment of FIG. 5, the issuer FI 410 transmits an OTA provisioning request 501 to a Data Preparation Bureau 422 with the customer's data (including payment account information, and the like) obtained during the service subscription process 400 of FIG. 4. The Data Preparation Bureau 422 transmits 503 a key derivation request (such as, for example, an EMV key derivation request message) to the issuer and SE Key Store 418 of the Web Service 414. For example, the EMV key derivation request message may be transmitted to a service such as the MasterCard Key Management Service (“KMS”) to initiate EMV data preparation processing. In some embodiments, key management may be handled by other entities (such as, for example, a Service Provider Trusted Service Manager (SP TSM) on behalf of the issuer FI). The Data Preparation Bureau also transmits 505 an OTA provisioning request message to the SP TSM 412 with the EMV personalization data. The SP TSM 412 then transmits 507 the final eligibility check request to the SEI TSM 408 for customer NFC service subscription.

In some embodiments, the SP TSM 412 also interacts 509 with the customer or end user 402 to perform activation or verification code processing. In such cases, the customer enters his or her activation or verification code into the mobile device 404 which transmits the activation or verification code to the SP TSM 412. In such implementations, after verifying the activation or verification code the SP TSM 412 transmits 511 a MMPP provisioning load/installation request message via a BIP channel to the Secure Element 406, which may be a UICC in the mobile device 404. The SP TSM 412 then performs 513 MMPP personalization via the BIP, and in some embodiments, the SP TSM 412 transmits 515 a push notification for MasterCards' Mobile PayPass user interface (MMPP UI) download from a third party application server (which may be via SMS with a uniform resource locator (URL)) to the mobile device 404. The end user 402 then interacts with the mobile device 404 which transmits 517 registration information to the SPT TSM 412 with activation data. The SP TSM 412 then transmits 519 a MMPP UI binding request to the SEI TSM 408. The binding request allows an application installed on the mobile device 404 to communicate with an application inside the Secure Element 406. In some embodiments, the application on the mobile device 404 is a graphical user interface (GUI) which communicates with the MMPP (the application inside the secure element 406), which are thus bound once the process executes. Referring again to FIG. 5, the SET TSM 408 transmits 521 a MMPP UI binding request to the Secure Element 406 to provision the mobile device 404.

Thus, in accordance with some embodiments, once the push personalization processing (items 511-521) is completed, the mobile device 404 and secure element 406 will have been personalized with PayPass application data and payment information. The SP TSM 412 will complete the process by sending 523 a status change notification (signifying the successful completion of personalization processing) to the SEI TSM 408. The mobile device 404 may then be used to conduct NFC payment transactions.

FIG. 6 illustrates a second embodiment of a personalization process 600. In particular, FIG. 6 depicts a “pull” personalization embodiment. The issuer FI 410 transmits 601 an OTA provisioning request to the Data Preparation Bureau 422 with the customer's data (including payment account information, and the like). The Data Preparation Bureau 422 then transmits 603 a key derivation request (such as, for example, an EMV key derivation request message) to the Issuer and SE Key Store 418. For example, an EMV key derivation request message may be transmitted to a service such as the MasterCard KMS of the Issuer and SE Key Store 418 to initiate EMV data preparation processing. This key management may be done by other entities (such as, for example, a Service Provider TSM on behalf of the Issuer). The Data Preparation Bureau 422 also transmits 605 an OTA provisioning request message to the SP TSM 412 with EMV personalization data. The SP TSM 412 then sends 607 the final eligibility check request to the SEI TSM 408 for customer NFC Service Subscription. Next, the SP TSM 408 transmits a load/installation request to an entity or service provider operating the system, which in some implementations is also transmitted 609 via the BIP or HTTP or any other channel to the Secure Element 406 of the Mobile Device 404 (but it should be understood that the load/installation request may be transmitted to the Secure Element 406 via HTTP or any other channel). In some embodiments, either a “simple mode” or a “delegated mode” of operation may be used to perform the installation process.

Referring again to FIG. 6, the SP TSM 412 transmits 611 a Push Notification to the Mobile Device 404 to check the readiness for personalization of the mobile device and to an application URL for downloading a payment application. The application URL may be transmitted to the mobile device via an SMS communication or the like. The end user 402 then interacts with his or her mobile device 404 to transmit 613 customer MMPP UI registration data to the SP TSM 412 and request for activation. The SP TSM 412 next transmits 615 MMPP and MMPP UI Binding Request to the SEI TSM 408, which transmits 617 the UI Binding Request to the SE 406 of the mobile device. (Thus, activation may include several interactions in which the SP TSM and an entity, such as MasterCard International Incorporated, interact to perform UI binding requests.) In some embodiments, the SP TSM 412 also interacts with the customer or end user 402 to perform PIN verification processing. In such cases, the customer enters his or her PIN into the mobile device 404, which transmits 619 the PIN to the SP TSM 412. In such implementations, after verifying the activation or verification code, the SP TSM 412 performs 621 a MMPP personalization via the BIP or HTTP or other channel. The personalization data is transmitted to and caused to be stored in a secure element of the mobile device.

Once the pull personalization processing is completed (items 611-621), the mobile device 404 and Secure Element 406 will have been personalized with PayPass application data and payment information. The SP TSM 412 will complete the process by sending 623 the status change notification (signifying the successful completion of personalization processing) to the SEI TSM 408. The mobile device 404 may then be used to conduct NFC payment transactions.

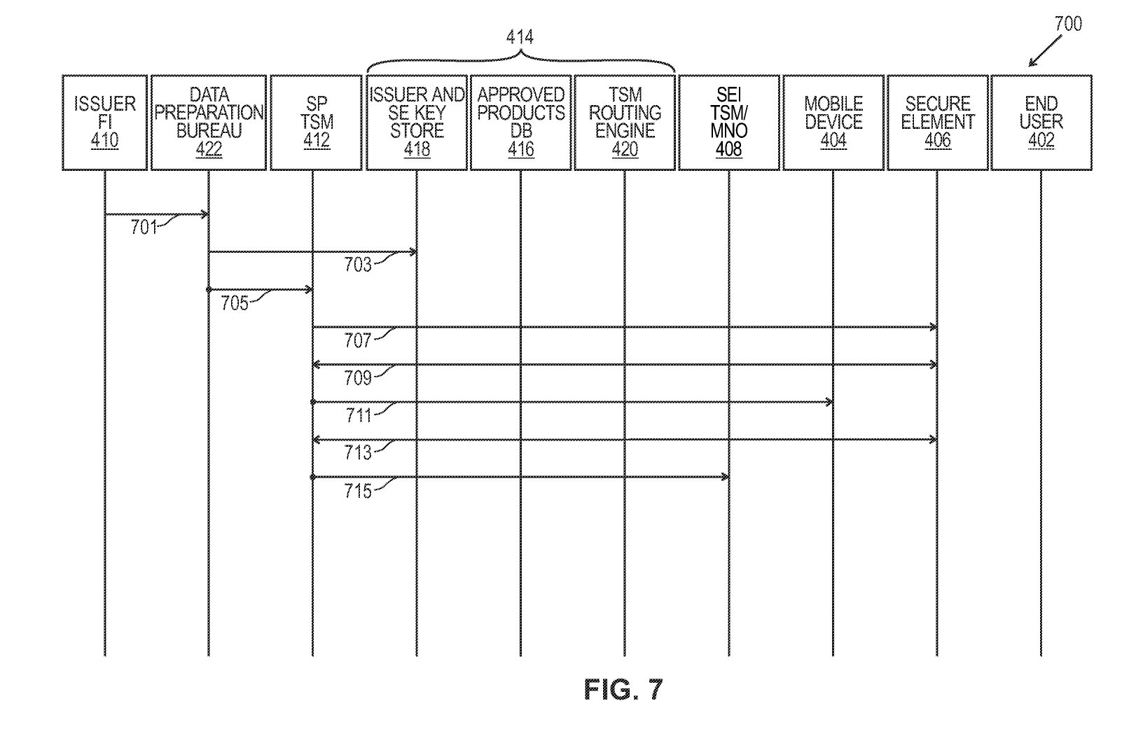

FIG. 7 is a flow diagram illustrating a service update process 700 according to some embodiments. The service update process 700 may be performed to update information or data associated with an NFC device such as mobile device 404 that has been provisioned (for example, using the process of FIG. 5 or of FIG. 6, discussed above). For example, a service update process may be performed to update details, code or other information (such as one or more attributes of the payment application) associated with a previously personalized mobile device.

In some embodiments of the service update process 700, the issuer FI 410 transmits 701 an OTA update request to the Data Preparation Bureau 422 with customer data associated with the mobile device to be updated. In an EMV implementation, the Data Preparation Bureau 422 transmits 703 an Issuer EMV key derivation request to a KMS entity or key management system (such as the MasterCard KMS service (Issuer and SE Key Store 418) or another third party KMS service) for data preparation. The KMS system, in response to the key derivation request, will conduct a data preparation (such as EMV data preparation). The Data Preparation Bureau 422 also transmits 705 an OTA provisioning request to an SP TSM 412 with personalization data on behalf of the issuer FI 410. However, in some embodiments, the Data Preparation Bureau 422 is bypassed by the issuer because data preparation is not required, and thus the issuer instead directly contacts the SP TSM 412.

Referring again to FIG. 7, the SP TSM 412 sends 707 a delete or update request message via the BIP or HTTP or other channel to the Secure Element 406 associated with the mobile device 404 to be updated. Either a simple mode or delegated mode of operation may be used. In some embodiments, the update may be performed using a “push” mode of operation in which the SP TSM 412 transmits 709 a re-personalization request to the Secure Element 406 via the BIP or HTTP or other channel, and the SP TSM 412 also transmits 711 a push notification to the mobile device 404 for the readiness of the update. However, in some embodiments, the update may be performed using a “pull” mode of operation in which the SP TSM 412 transmits 713 a re-personalization request to the Secure Element 406 via mobile data transmitted to the mobile device 404 (which was requested by the mobile device). Upon update (utilizing either the “push” mode of operation or the “pull” mode of operation), the SP TSM 412 sends 715 a status change notification to the SEI TSM 408.

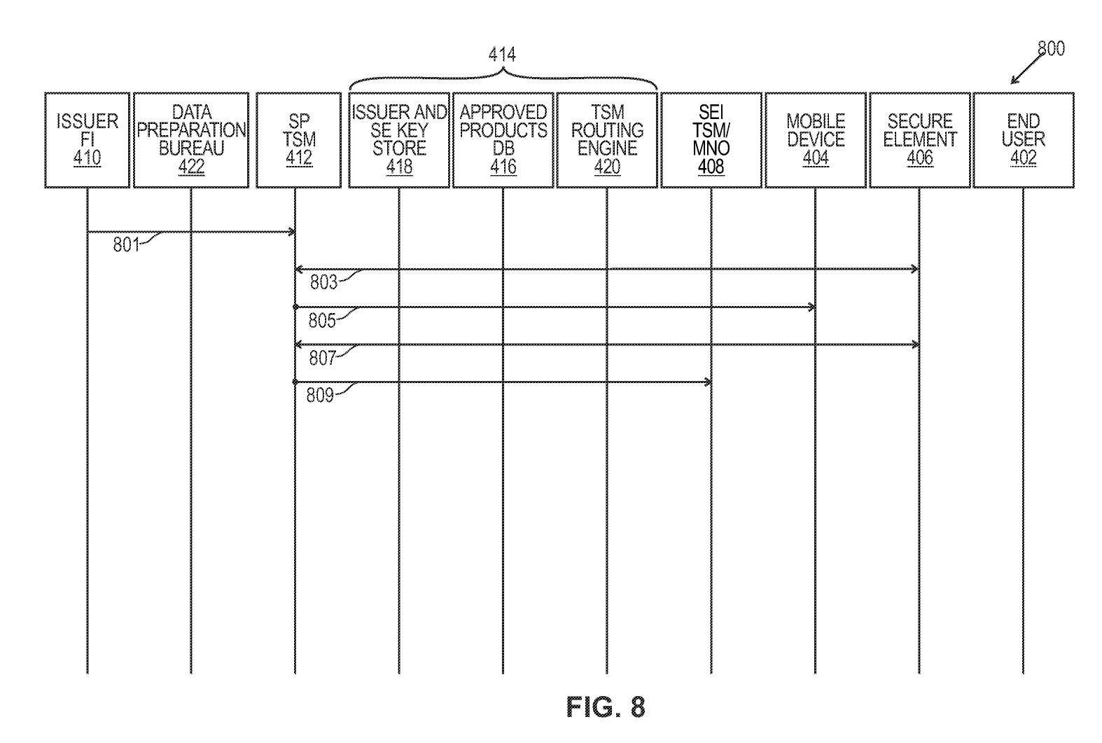

Reference is now made to FIG. 8 where a service enable/disable process 800 pursuant to some embodiments is shown. A service enable/disable process may be performed when the payment application that has been previously installed on a mobile device requires reset or disabling (for example, in the event of fraud or the like). In some embodiments, the issuer FI transmits 801 an enable/disable request to the SP TSM 412. In the case of a “push” mode of operation, the SP TSM 412 transmits 803 an enable/disable request message to the Secure Element 406 via the BIP or HTTP or other channel. Upon completion, the SP TSM 412 sends 805 a push notification to the mobile device 404 for the enable/disable operation. In the case of a “pull” mode of operation, the SP TSM 412 transmits 807 an enable/disable request message to the Secure Element 406 via a mobile data connection. The SP TSM 412 also sends 809 a status change notification message to the SEI TSM 408 to complete the operation.

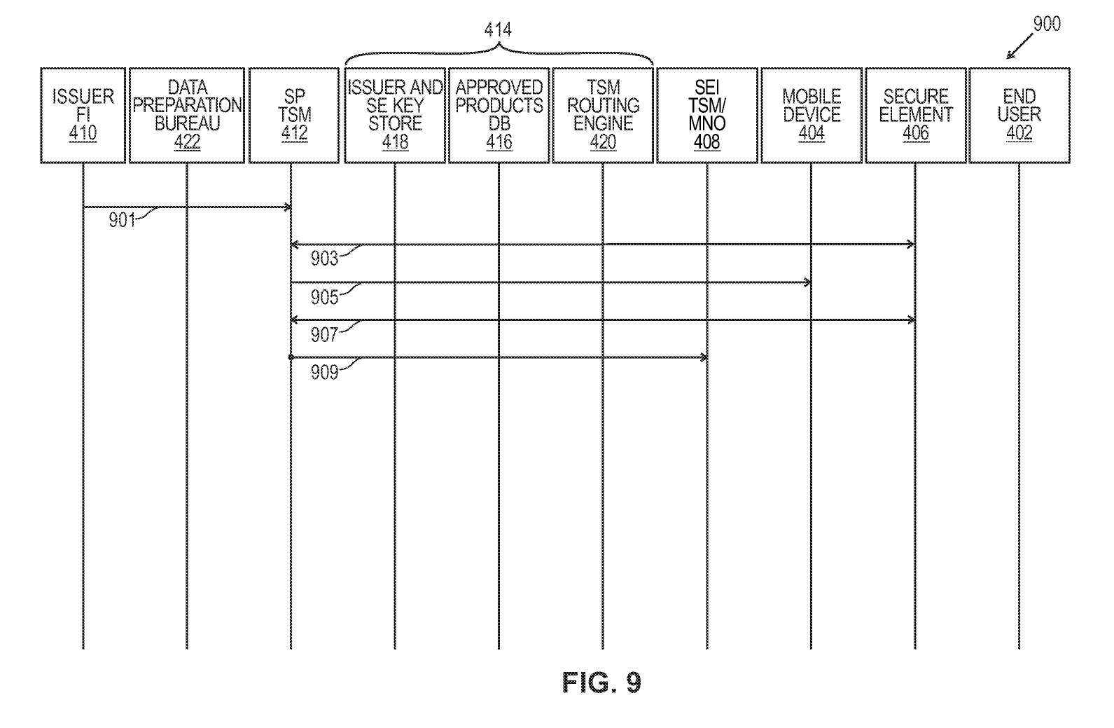

FIG. 9 illustrates a service removal process 900 according to an embodiment. In some implementations, a service removal process may be performed to remove the payment application from a mobile device 404 and Secure Element 406. The process begins when the issuer FI 410 sends 901 a deletion request message to the SP TSM 412. In the case of a “push” mode of operation, the SP TSM 412 transmits 903 a deletion message to the Secure Element 406 via the BIP or HTTP or other channel, and transmits 905 a push notification to the mobile device 404. In the case of a “pull” mode of operation, the SP TSM 412 sends 907 a deletion request message to the Secure Element 406 via a mobile data connection. To complete the deletion process, the SP TSM 412 transmits 909 a status change notification to the SEI TSM 408.

In some embodiments, the above descriptions and depictions of processes should be considered to mandate a fixed order for performing process steps as a final framework may require such processing. However, in some embodiments the process steps described herein may be performed in any order that is practicable.

Several specific exemplary embodiments have been described herein, but it should be understood that various changes, substitutions, and alterations may be made by those skilled in the art to the disclosed embodiments without departing from the spirit and scope of the disclosure as set forth in the appended claims.

What is claimed is:

1. A method comprising:
providing, by a mobile device provisioning framework system, standardized interface specifications, standardized messaging specifications, and a plurality of predetermined mobile device standard profiles;
receiving, by the mobile device provisioning framework system from an issuer computer, a selection of a standard profile; and
provisioning, by the mobile device provisioning framework system, a consumer's mobile device based on the selected standard profile.

2. The method of claim 1, further comprising, prior to receiving the selection of a standard profile:
receiving, by the mobile device provisioning framework system, a mobile device eligibility request from an issuer computer;
comparing, by the mobile device provisioning framework system, information in the mobile device eligibility request to data stored in an approved products database; and
transmitting, by the mobile device provisioning framework system, an eligibility confirmation message to the issuer computer when the information in the mobile device eligibility request matches data stored in the approved products database.

3. The method of claim 1, further comprising, prior to receiving the selection of a standard profile, providing a modification option to enable modification of at least one characteristic associated with a selected standard profile.

4. The method of claim 1, wherein provisioning comprises:
receiving, by the mobile device provisioning framework system, an over the air provisioning request comprising customer data;
transmitting, by the mobile device provisioning framework system to an issuer and secure element key store, a key derivation request to initiate EMV data preparation processing;
transmitting, by the mobile device provisioning framework system via a bearer independent protocol (BIP) channel, a load/installation request to a secure element of the customer mobile device; and
transmitting, by the mobile device provisioning framework system to a third party application server, a push notification to download a payment application to the secure element.

5. The method of claim 4, further comprising, before transmitting the load/installation request:
transmitting, by the mobile device provisioning framework system to the customer mobile device, a verification code request;
receiving, from the mobile device, a verification code; and
validating, by the mobile device provisioning framework system, the verification code.

6. The method of claim 1, wherein provisioning comprises:
receiving, by the mobile device provisioning framework system, an over the air provisioning request comprising customer data;
transmitting, by the mobile device provisioning framework system to an issuer and secure element key store, a key derivation request to initiate EMV data preparation processing;
transmitting, by the mobile device provisioning framework system via a communications channel a load/installation request to a service provider computer;
receiving, by the mobile device provisioning framework system, customer registration data from a customer mobile device; and
transmitting, by the mobile device provisioning framework system to a secure element of the customer mobile device, a UI binding request; and
personalizing, by the mobile device provisioning framework system via the communications channel, the customer mobile device.

7. The method of claim 6, further comprising, before personalizing the customer mobile device:
transmitting, by the mobile device provisioning framework system to the customer mobile device, a verification code request;
receiving, from the mobile device, a verification code; and
validating, by the mobile device provisioning framework system, the verification code.

8. The method of claim 6, wherein the communications channel comprises one of a bearer independent protocol (BIP) channel or a HTTP channel.

9. A mobile device provisioning framework system comprising:
a data preparation bureau computer configured for communicating with an issuer computer;
at least one service provider, trusted service manager (SP TSM) computer comprising an issuer/SP TSM standard interface for communicating with the issuer computer, the SP TSM computer also configured to communicate with the data preparation bureau computer and to provision a consumer's mobile device; and
at least one secure element issuer trusted service manager (SEI TSM) computer configured for communications with the SP TSM computer and with the consumer's mobile device;
wherein the SP TSM computer further comprises a plurality of predetermined mobile device standard profiles for selection to provision the consumer's mobile device.

10. The system of claim 9, further comprising a web service computer system configured for communications with the SP TSM computer and with the data preparation bureau computer, the web service computer system configured for checking the consumer's mobile device for compatibility with a provisioning service.

11. The system of claim 10, wherein the web service computer system comprises at least one of an approved products database and an issuer and secure element key store.

12. The system of claim 11, wherein the approved products database stores data identifying certified mobile devices and secure elements for use in confirming eligibility for use with at least one mobile payment application.

13. The system of claim 11, wherein the issuer and secure element key store is configured to allow simplified key exchange and distribution for use in provisioning the consumers' mobile device.

14. The system of claim 9, further comprising an SP TSM/SEI TSM standard interface to facilitate communications between the SP TSM computer and the SEI TSM computer.

15. The system of claim 14, wherein the SPT TSM/SEI TSM standard interface is based on Global Platform specifications.

16. The system of claim 9, further comprising an SEI routing interface for providing over-the-air (OTA) provisioning from the SEI TSM to the consumers' mobile device.

17. The system of claim 9, wherein the issuer/SP TSM standard interface is based on a MasterCard International Incorporated Open Application Programming Interface (API) and Global Platform specifications.

18. The system of claim 9, wherein the issuer/SP TSM standard interface supports both real time and batch file processing of mobile device provisioning requests.
